(19) United States
(12) Patent Application Publication
(10) Pub. No.: US 2010/0306276 A1
(43) Pub. Date: Dec. 2, 2010

(54) DYNAMIC GROUP LABELS

(75) Inventors: Marc E. Davis, San Francisco, CA (US); Chris W. Higgins, Portland, OR (US); Simon P. King, Berkeley, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/472,302

(22) Filed: May 26, 2009

(51) Int. Cl. G06F 17/30

(52) U.S. Cl. 707/803; 707/802; 707/812

(57) ABSTRACT

Disclosed are methods and apparatus for managing dynamic groups. In one embodiment, a method of creating or modifying a group of users is disclosed. A request is received from a first user to create or modify a current group. One or more rules are also received from the first user for specifying members of the current group based on user information that was or will be collected for a plurality of users. In one embodiment, the collected user information includes at least user presence information or user communication data. A membership policy for the current group is then retained based on the received one or more rules. The membership policy for the current group is accessibly usable so as to dynamically allow a selected set of users, who each have corresponding collected user information which meets the membership policy, to become members of the current group, wherein the selected set of users is changeable over time as different user information is collected over time.

### BACKGROUND OF THE INVENTION

The present invention is related to techniques and mechanisms for providing group memberships policies for various applications within a computer network.

There are various reasons for maintaining user groups or membership lists. For example, a membership group may be specified to allow access to particular files on a directory server. In another example, a membership group may be formed as an email recipient distribution list. Maintaining groups or lists of people is usually a tedious manual process. Accordingly, there continues to be a need for improved mechanisms for creating and managing user groups.

### SUMMARY OF THE INVENTION

In certain embodiments, mechanisms for managing dynamic groups have been disclosed. In one embodiment, a method of creating or modifying a group of users is disclosed. A request is received from a first user to create or modify a current group. One or more rules are also received from the first user for specifying members of the current group based on user information that was or will be collected for a plurality of users. In one embodiment, the collected user information includes at least user presence information or user communication data. A membership policy for the current group is then retained based on the received one or more rules. The membership policy for the current group is accessibly usable so as to dynamically allow a selected set of users, who each have corresponding collected user information which meets the membership policy, to become members of the current group, wherein the selected set of users is changeable over time as different user information is collected over time.

In one aspect, the set of users that are members of the current group is periodically updated based on the membership policy for such current group, and each periodic updating operation is based on a current set of collected user information. In a specific implementation, the membership policy is based only on user information that has been verified to meet a predefined reliability specification. In another specific implementation, the one or more rules each specify one or more of the following: a user type, a user location, or a time and wherein the one or more rules specify at least one conditional operator. In a further aspect, the user type is specified by one or more other rules. In yet a further aspect, the user type specifies a category of social relationship with respect to the first user. In another embodiment, one or more suggested rules are suggested to the first user for the current group so that the first user may include any of the one or more suggested rules in the one or more rules from the first user, and the one or more rules are obtained from previously received rules from other users.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a procedure for group management in accordance with one embodiment of the present invention.

FIG. 3 is a flow chart illustrating a membership management procedure in accordance with a specific implementation of the present invention.

FIG. 4A illustrates a user presence table in accordance with one embodiment of the present invention.

FIG. 4B illustrates a communication table in accordance with one embodiment of the present invention.

FIG. 5 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Certain embodiments of the present invention provides a mechanism for using rules to set criteria for group membership so as to shift ongoing group maintenance to a one-time task of setting membership conditions. Additionally, this method of setting group membership can allow groups to be set up “in advance”. That is, people who are not yet users of a given system can be automatically added to a group at a future time when they meet the membership criteria. In general, the membership criteria for a particular group can be defined by a set of conditional operators (e.g., Boolean operators) that are applied to user information, such as user presence or communication data, as further detailed below.

Although particular example uses of dynamic groups are described below, dynamic groups can be utilized for any suitable application. Additionally, although the following mechanism for creating and managing dynamic groups are described as being based on specific types of user information, such as presence or communication data, other types of user information may be used to form dynamic groups. Although the following group definitions are described mainly in terms of users who meet each particular criteria (such as place and time criteria), groups may also be defined in other ways, such as a list of people who meet a time criteria for a particular place criteria, as people who were in Sunnyvale, Calif. three times last week. This last group example builds a 2^{nd} order membership time criteria from the base criteria (“been in Sunnyvale, Calif.”).

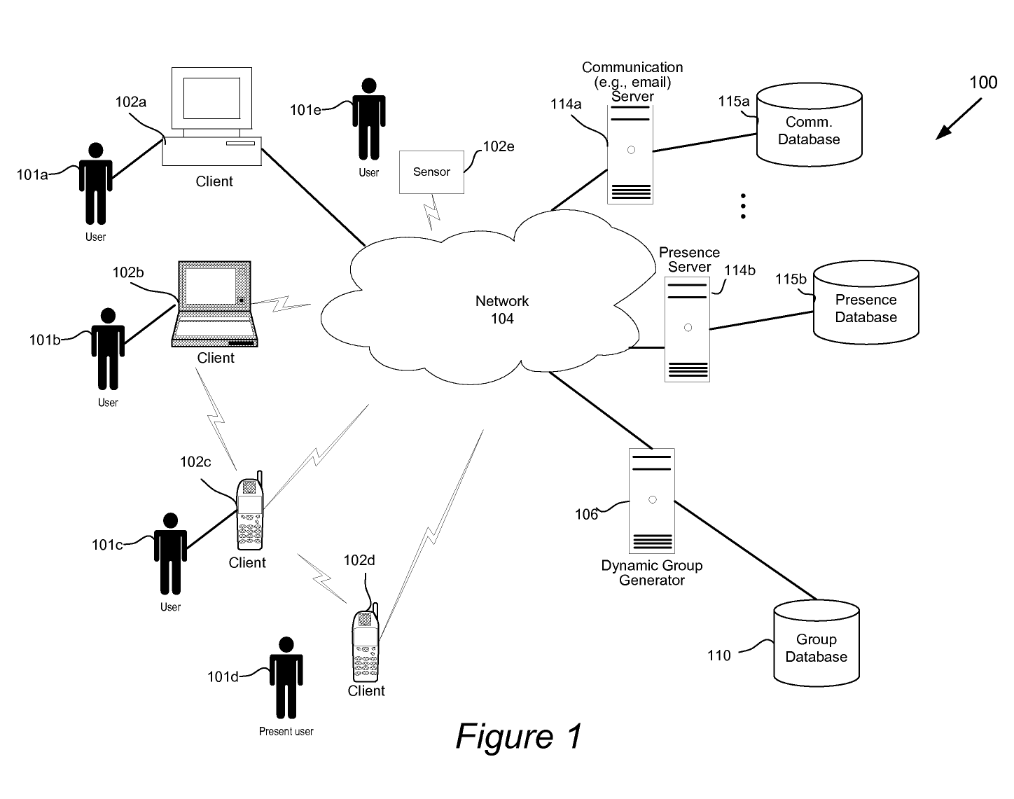

Prior to describing detailed mechanisms for creating and managing groups, a computer network architecture will first be briefly described to provide an example context for practicing techniques of the present invention. FIG. 1 illustrates an example network segment 100 in which the present invention may be implemented in accordance with one embodiment of the present invention. As shown, a plurality of clients 102a˜e may access various servers, for example, communication server 114a or presence server 114b via network 104 so that a variety of user information, e.g., related to users 101a˜e, may be tracked and retained for later use by a dynamic group generator, such as server 106. Each server (e.g., 114a, 114b, 106) may have access to one or more web database(s) (e.g., 115a, 115b, or 110) into which information (e.g., user or group information) is retained.

The network may take any suitable form, such as a wide area network or Internet and/or one or more local area networks (LAN's). The network 104 may include any suitable number and type of devices, e.g., routers and switches, for forwarding requests from each client to a particular server application, forwarding application results back to the requesting clients, or forwarding data between various servers.

Embodiments of the present invention may also be practiced in a wide variety of network environments (represented by network 104) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, mobile networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A communication server (e.g., 114a) may implement a communication application, such as email, instant messaging, IP telephony, etc. A communication application generally allows a user (human or automated entity) to communicate with one or more other users via a communication device (e.g., telephones, persona digital assistants or PDA's, computers, etc.) via one or more networks (e.g., 104) and retain user communication information, for example, in communication database 115a. Embodiments of the present invention may be employed with respect to communication data obtained from communication server applications or generated from any communication application, such as general communications applications that include Yahoo! Email, Yahoo! IM, Facebook chat, etc. The communication applications may be implemented on any number of servers although only a single communication server 114a is illustrated for clarity and simplification of the description.

A presence server (e.g., 114b) may implement a mechanism for retaining presence information regarding, for example, a plurality of registered users, e.g., in presence database 115b. Presence data may include such user's locations during specific times as explained further below.

Embodiments of the present invention may include a dynamic group generator system or server 106 for creating and managing groups, for example, of users. The dynamic group generator may be implemented within another application server, such as presence server 114b or communication server 114a or on a separate server, such as the illustrated dynamic group generator system 106. In general, the dynamic group generator is configured to allow the creation and management of groups based on predefined rules or group policies. The dynamic group generator 106 may access one or more group databases, e.g., group database 110, for group policies and rules, group membership lists, etc.

The dynamic group generator 106 may also be configured for various other related tasks, such as managing the privacy rights of users. For example, dynamic group generator 106 may provide privacy control for the user information that can be accessed and used to form groups. By way of example, a user may not want presence information for particular venues (e.g., a strip club) to be accessed and used to form groups. In one embodiment, each user can configure one or more access models for specifying which user data (e.g., presence or communication data) may be accessed for (or excluded from) use in dynamic group formation techniques.

User information for use in dynamically forming groups may be collected in any suitable manner. For example, a user may self-report user information and/or user information may be automatically collected as the user interacts with the computer network or various networked devices, which are equipped with automatic self-reporting features. In one implementation, each user registers (e.g., with dynamic group generator 106) to participate in groups. Users can register at any time, even after certain group policies have been defined. During registration (or at a later time), a user may supply various user information, such as contact information, interests, occupation, family information, etc.

After user registration, user data may also then be periodically collected from the registered user as further described below. For example, presence data for each user may be periodically collected as each user changes his/her location. The collection of user data may be triggered by any suitable event. In one implementation, user data that pertains to specific user activities may be collected when users perform such specific activities or perform a predefined threshold of such specific activities.

Data relating to the user location can be obtained from a variety of sources including humans and devices such as cellular telephones, mobile computing or gaming devices, appliances or vending machines, private or public vehicles, private or public buildings and sensors. Location data could be provided by the user or the user's device. For example, a user may engage in various online activities that can provide location data. For example, a user may belong to one or more user websites, such as a social networking website (e.g., Facebook website) or a microblogging site (e.g., the Twitter website). Personal blogs or websites may also contain content created or annotated by the user and published on an interconnected network for consumption and enjoyment by other users. The user's online activities, such as what web sites are visited, how long each website is visited, and what the user clicks on or interacts with (e.g., via a pointing device, such as a mouse or cursor) may also be traced and stored by the user, a network, or third-party service provider. A user may explicitly post a status message to such sites indicating his or her current location or an intended destination or series of locations and associated times of expected presence (which could be remote in time.) A user may also send emails indicating the user's current location or intended destination as well as communicated interactively through speech or IM in real-time with other users such that all of these channels may be sources of data regarding user location or destination including weighting the reliability of specific data instances or values based upon entity extraction from communications before, during or after the location/time data seeking to be verified. Of course, a user may also be able to directly post a stated location for the service to use via, for example, a webpage or a text message.

Location data could be obtained from communications networks. In the illustrated example, users 101c and 101d may both have phones 102c and 102d connected to a mobile network such as a CDMA or GSM network. One of these users may also have a Personal Data Assistant (PDA) that is communicatively connected to a wireless network. The position of the user's devices 102c and 102d could be determined or approximated using any conventional technique such as triangulation of cell signals or the location of the nearest cell tower. The user's devices 102c and 102d could also include other sensors, such as GPS sensors, which could provide a relatively precise geographical position as well as biometric or orientation-in-space data. Successive sets of data could be analyzed to determine a real-time rate and direction for any motion as well as to establish individual, archetype user, and aggregated user patterns and trends, which becomes valuable data in weighting the reliability of future location data instances.

Location data could be obtained from sensor networks. In the illustrated example, user 101e is within the sensing radius of one or more sensor 102e. The sensors 102e could be any kind of sensor capable of identifying an individual with a reasonable degree of accuracy including but not limited to RFID tag readers, biometric sensors, motion sensors, temperature or weather sensors, access sensors, security sensors or multimedia stream sources including real-time feeds from on scene users with multimedia streaming or capture enabled devices, appliances, vehicles, buildings, etc. For example, the sensors 102e could be any kind of biometric sensors, such as a facial recognition system or a fingerprint scanner. The sensors 102e could be scanning devices for user identification credentials, such as a driver's license. The sensors could be RFID sensors that sense RFID devices associated with a user through, for example, a user device such as a cell phone 102c or laptop 102b, in which an RFID device is embedded. Other known types of objects or people, in which RFID devices may be embedded, include people, clothing, vehicles, jewelry and child or elderly protection or monitoring devices.

Location data for one user could be provided by another user. For example, user 101a could provide a stated location for another user. For example, user 101a could post a status message to a website or send an email that indicates user 101c is, or will be, in a specific place at a specific time. One user's device could recognize the presence of another user's device in a given location. For example, a PDA 102c of user 101c, could use a short range communication protocol such as the Bluetooth protocol, recognize that cellular phone 102d of user 101d is within range of the PDA and transmit such information to the presence server 114a through one or more networks 104. A user device could be used to request a user to explicitly verify the presence of another user in a given location. For example, the presence server 114a could send an inquiry to user 101a via a text message, an email or an instant messages requesting user 101a to verify that user 101b is in a given location or co-present with one or more additionally specified users or objects.

Location data could also be provided through one or more third party location data providers. This may be necessary under circumstances where location data cannot be directly obtained from a communications or sensor network, such as foreign jurisdictions which strictly control location data for privacy or national security reasons. Location data may also be obtained from local area sensor networks, such as video feeds, local wifi or other presence or identity enabled processes, appliances or devices that sense and record users and/or their activities at one or more locations. For example, a theme park or access-controlled home owners association gathers data on users and their locations, their comings and goings, which may be then offered in real-time or post-event to others on a free or fee-basis.

Mechanisms may also be employed for verifying collected user data (e.g., verifying that user presence data is accurate). That is, only collected user data that meets a predefined reliability specification can be used to dynamically allow selected users to become members of a group (e.g., based on a membership policy for such group). For example, collected user information that is deemed as unreliable may be excluded from being used to form group memberships. In one embodiment, reliability of a given user, sensor or user information may be determined on a typological basis, on an empirical basis or both. A user may be assigned to one or more types or archetypes based on any number of factors that describe the user. Such factors may include demographic factors such as age, nationality, gender, income, wealth, educational level and profession. Such factors may include the user's interests such as a favorite type of music, literature, hobby or other activities. Such factors may include metrics about the user's behavior on the Internet, such as the number of social networking websites the user is a member of, the number and frequency status messages posted by the user, the number of emails sent by a user, original content or content annotations published by the user, and so forth.

As a presence system accumulates data, it may become obvious that certain types of users and/or devices are reliable sources of location data. For example, users between the age of 25-35 with graduate degrees who post status messages to social networking or microblogging services 10 times per day may be more reliable sources of location data because their regular supplying of explicit location data provides a more reliable path through space time of their actual locations than users who provide or create less explicit location data. On the other hand, users over the age of 55 who rarely or never send emails, instant messages or post status messages may be less reliable sources of information. In all cases, a user's co-location with a device such as a cellular telephone or computing device that has a passive sensing capability enables a means to track their location implicitly without any need for status or location updates explicitly from the user.

When a user first becomes known to a verified presence tracking service, the user could be assigned a default reliability score, or, alternatively, could be typed by one or more factors associated with that user and assigned an initial reliability based on such a type. For example, users who regularly shut off their devices or who have a history of post event editing of their location data may be given a lower reliability score based upon their explicit attention to passive location data being gathered on them and/or an established pattern of falsifying or editing passively gathered location data. Reliability may also relate to the number and sophistication of sources. For example, a user with three co-present mobile devices gathering passive location data is far more reliable than a user with only one such device. Uses with GPS-enabled devices are more reliable than those with only cell-tower level location granularity.

After a sufficient amount of verified presence data is accumulated regarding a user, it may be possible to determine the reliability of a user as a source of location data empirically, which is to say, on the basis of data alone. Thus, for example, a user who is typologically within a group that is generally considered to be reliable, may be found to be unreliable. For example, a user between the age of 25-35 with a graduate degrees who posts status messages to social networking or microblogging services 10 times may habitually post misinformation regarding his or her location or lends his or her mobile devices to other users.

A sensor may be assigned to one or types based on any number of factors that describe the sensor. Such factors may include basic types of technology, such as GPS sensors, RFID sensors, short range wireless sensors using protocols such as the Bluetooth protocol, or biometric sensors. Such factors may include the sensor's brand, or model number, or whether the device is running trusted client software or untrusted client software. When a sensor first becomes known to a verified presence tracking service, the sensor could be assigned a default reliability, or, alternatively, could be typed by one or more factors associated with that sensor and assigned an initial reliability based on such a

After sufficient amount of verified presence data is accumulated regarding a specific sensor, it may be possible to determine the reliability of the sensor as a source of location data empirically. Thus, for example, a sensor that is typologically within a group that is generally considered to be reliable may be found to be unreliable. For example, a GPS sensor may be considered to be generally reliable, but a given user's device may contain a GPS sensor that is defective or whose operation is impaired by the device in which it is embedded.

As user data is collected (and optionally verified), for example, by presence and communication servers, such user information can then be used as criteria for user membership in specific groups for use in various activities. For example, a mailing list of Sunnyvale Yahoo! employees could be defined as users with a yahoo-inc.com email address who have physically been present on the Sunnyvale Yahoo! campus for at least 10 days in the last month. Such a hypothetical group definition may be easier to maintain, as compared with the Yahoo! facilities department to track employees that have moved offices to San Francisco. As another example, person A can organize his/her address book into “drinking buddies” (people who person A is co-present with on Friday evenings in San Francisco), “good friends” (people who person A has called or emailed at least 3 times in the past month and 10 times in the past year), “immediate family” (people who are frequently at person A's house in the middle of the night), and “college acquaintances” (people who person A has responded to email from with an amherst.edu email address).

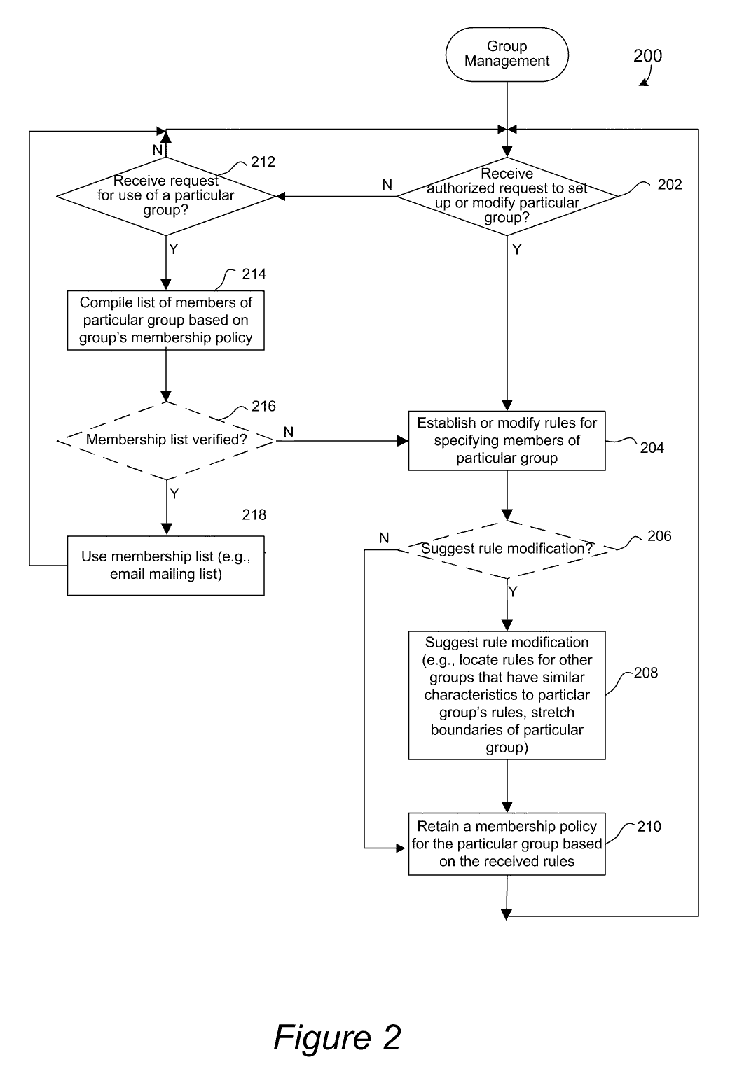

Mechanisms for creating and managing dynamic groups can be implemented in any suitable manner. FIG. 2 is a flow chart illustrating a procedure 200 for group management in accordance with one embodiment of the present invention. The following procedure may be implemented with respect to any number and type of dynamic groups. For example, one or more users may create and/or modify a diverse number and type of groups having differing membership criteria.

In the illustrated example, it may initially be determined whether an authorized request has been received to set up or modify a particular group in operation 202. For example, a user may send a request to form or modify a particular group to dynamic group generator server 106. Each new group may be associated with a unique name for referencing such new group and a unique user identification that corresponds to the user who is creating such group. A particular users may be identified by any suitable identifier, such as by cookies (or other identifying information) that are associated with a user during a login process or by the user's particular client device identity (although not as reliable since multiple users may use a same client device or a user may use multiple client devices at various times).

Any user may have authorization to create a group. However, a creator of a particular group may be the only person who is authorized to modify such particular group. Alternatively, the group's creator may delegate modification authority to one or more users. A user may be authorized to modify a group's policy in a limited manner. For example, a user can be authorized to modify the group's policy so that the membership list is only expanded and not contracted so as to exclude people who were already on the membership list. In another example, a user may be authorized to modify a group in any manner that does not result in the creator to be excluded from such group. These various rights for how a user can modify a particular group may be retained and associated with the particular group, for example, in the form of a rights model.

If a request for creating or modifying a particular group has been received, rules for specifying members of the particular group may be established or modified in operation 204. Mechanisms for establishing or modifying rules for group membership are further described herein. In general, any suitable criteria may used by a group creator (or modifier) to dynamically define a group membership. For example, users that meet certain defined requirements with respect to their presence or communication data may attain group membership.

It may also be determined whether a rule modification is to be suggested in operation 206. If a rule modification is to be suggested, a rule modification is then suggested in operation 208. Otherwise, this operation is skipped. Any number and types of rules may be suggested to the requester. For example, rules for other groups that have similar characteristics to the particular group's established or modified rules may be located and suggested to the requester. In another example, it may be suggested that the boundaries of particular group's rules be stretched (e.g., incrementally).

A membership policy for the current group may then be retained based on the received rules in operation 210. For example, the requester's rules that have been established or modified for the particular group, as well as any selected suggested rules, are retained in association with such particular group. The group management procedure 200 may then repeat.

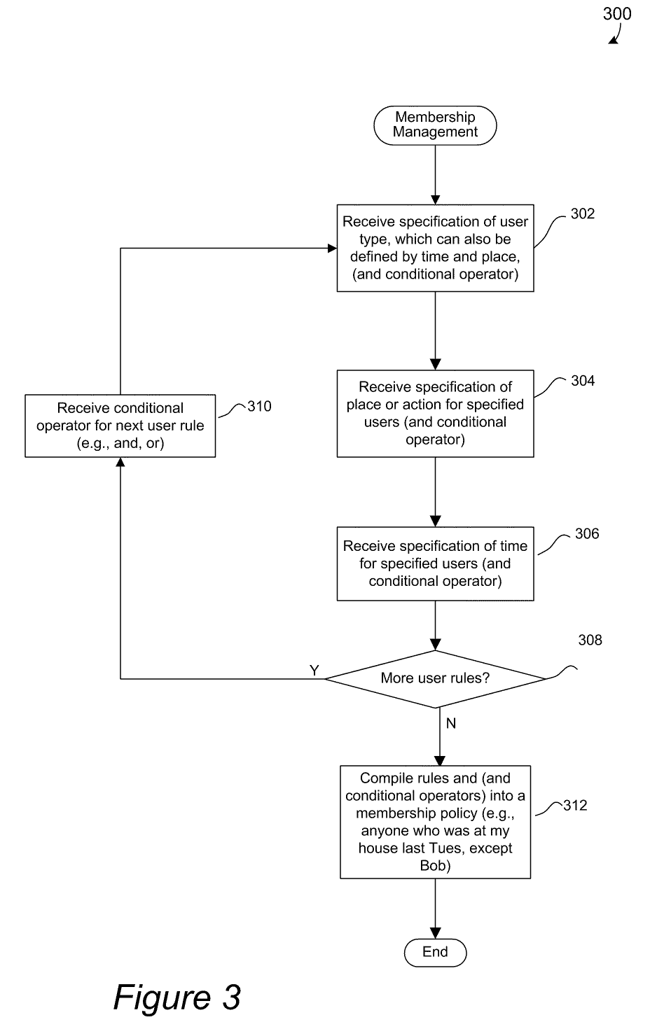

Membership rules and policy for a particular group may be defined using any suitable mechanism. FIG. 3 is a flow chart illustrating a membership management procedure 300 in accordance with a specific implementation of the present invention. In general, the procedure 300 includes a mechanism for a user to specify a policy with respect to a particular group although such procedure may be applied to any suitable number of groups. Initially, a specification of user type (and optionally a conditional operator) for a current rule may also be received (from a user 102a by the dynamic group generator system 106) in operation 302. For example, a user type may be specified simply as anyone or no one. For example, the current rule or group policy may specify that everyone or no one is allowed to be a member of the current group. A user type may also specify a particular user, such as Bob or a specific category of social relationship with respect to the creator of the current group. Some example social relationship categories may include family, friends (close friends, college friends, high school friends, drinking buddies, acquaintances, etc.), coworker, etc. A conditional operator may also be specified for the particular user type. For example, a conditional operator may include “not”, “except”, etc. For instance, the current rule specify “not Bob” or “except Bob” for the current group.

A user type may itself be defined by a rule. In one implementation, a user type may be defined by users who meet specific place, time, and/or activity requirements. For example, a group creator may specify the user type “family” to be defined as “a user who is present within the rule creator's home every night or is present in the rule creator's home more than a predetermined percentage (e.g., 50%) of time.” In this example, user category “family” may dynamically change as more children join the family. In another example, a user category “close friends” may be defined as people who I contact at least once per week or people I meet at least once a week. These user category definitions can be generally based on a history of user actions. Other user types may include defined categories of users who have particular interests, such as cars, photography, politics, movies, American Idol, etc.

A criteria type (e.g., user type) that is selected a part of a rule may also trigger a mechanism for locating other rules or criteria to present as suggestions. For example, other users may have alternative ways to define “family”, which may be presented to the current user who is establishing or modifying a group policy. In another example, a most common family definition may be presented to the current user.

A specification of place or action (and conditional operator) for the specified users may also be received in operation 304. A particular place or geographical region (e.g., was at my house, was not at my house, lives in San Francisco, was present in San Francisco) may be specified for the current rule. User actions may include people who share resources (e.g., photos) or user information with me, and such user actions may be used to define a group policy for reciprocal sharing of similar resources or user information, for example. User actions may also include communication actions. For example, communication actions may pertain to the method of contact (e.g., person has emailed me, person has phoned me), the particular device (e.g., cell phone, home phone, computer, etc.) that was used for the communication, or the particular contact address (e.g., at my college or work email).

The specification of time (and conditional operator) for the specified users may also be received in operation 306. For example, people who were at my house last Tuesday anytime, this week, or during Christmas week may be specified for the current rule.

It may then be determined whether there are any more user rules (for the current group) in operation 308. If there are more rules, a conditional operator for the next user rule may then be received in operation 310. For example, the conditional operator may be in the form of a Boolean operator (e.g., except, and, or, not, etc.). The procedure for setting up a user rule may then be repeated in operations 302 through 306.

When there are no more user rules to be specified for the current group (the user indicated that he/she is has finished the group creation or modification process), the rules and relationships that have been specified for the current group may then be compiled into a membership policy for the current group in operation 312. For example, the group policy may specify anyone who was at my house last Tuesday, except Bob. This example group policy includes a first rule that specifies a person (anyone), a place (my house), and a time (last Tuesday), and a second rule that specifies a single user Bob, with a conditional operator “except” being applied for the 2^{nd} rule. In general, one or more specified rules and their respective criteria may include a conditional operator.

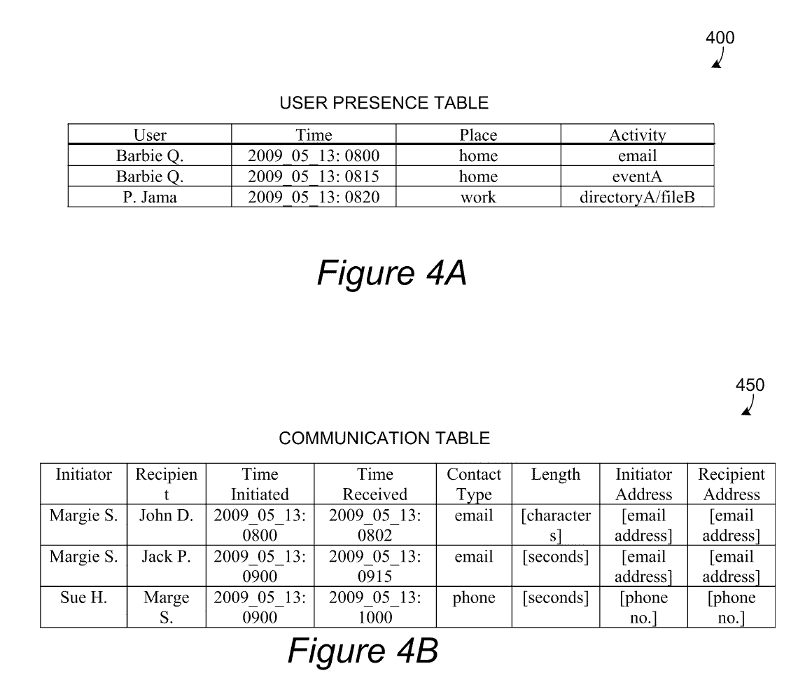

The rules of a group policy may be based on any suitable user information, such as presence or communication data. FIG. 4A illustrates a user presence table 400 in accordance with one embodiment of the present invention. As shown, each entry of the user presence table may include a user field for identifying a unique user, a time field for specifying a time and date, a place field for specifying a place at which the user was located for the specified time, and an optional activity field for specifying an activity in which the specified user was engaged during the specified time at the specified place. Alternatively, user activity information may be logged in other tables, such as a communication table.

FIG. 4B illustrates a communication table 450 in accordance with one embodiment of the present invention. Each entry in the communication table can specify details about a particular communication session between two or more users. As shown, each entry may include an initiator field that identifies the initiator of the communication session, a recipient field that identifies the recipient of the communication, a time initiated field, a time received field (e.g., when the email was opened), a contact type field (e.g., email, phone, IM, etc.), a length field (e.g., character count for email or text message, duration of phone call, etc), an initiator address field (e.g., phone number or email address), and a recipient address field(e.g., phone number or email address).

As illustrated, any suitable number and type of rules may be defined for a particular group. The policy or rules for a particular group can either be stored for later use or used immediately after such policy is defined. For instance, a user may define and then use a group policy as needed. Referring back to the group management process 200 of FIG. 2, it may periodically be determined whether a request for use of a particular group has been received in operation 212. When a request for a particular group is received, the list of members of the particular group may be compiled based on the group's membership policy in operation 214. Alternatively, each group's membership may be independently updated in any suitable manner, such as periodically updated or updated when trigger events occur (e.g., after any or a predetermined amount of new user information is collected).

A membership list may be complied based on a group policy in any suitable manner. For example, a database query (e.g., SQL) may be generated based on the specified group policy. The following SQL and table implementation examples are merely exemplary and are not meant to limit the scope of the invention. If the group policy specifies membership to include people who were at my house on at least 5 days in November 2008, the following SQL query could be performed on a presence table similar to that in FIG. 4A to return users who have met the criteria of such group policy:

select person, count(distinct(round(time, nearest day)) as number_of_visits from presence where time between “01-nov-08” and “01-dec-08” and place=“my house” group by person having number_of_vists=5.

In another example, if the group policy specified membership to include people that have been near me in November, the following SQL query could be performed to achieve such dynamic result:

select their_presence.person from presence their_presence, presence my_presence where their_presence.time between my_presence.time−“30 minutes” and my_presence.time+“30 minutes” and their_presence.place=my_presence.place and my_presence.person=me and my_presence.time between “01-nov-08” and “01-dec-08”

Queries could also be combined to achieve a particular group policy. For example, these later two queries could be combined to include users who have been near me in November and were also at my house on at least 5 days in November 2008.

Similarly, communication data (e.g., from communication table 450) could be accessed to allow queries such as:

select initiator, count(*) as c from communications where recipient=me and contact_method=email and (time_received−time_initiated) “3 days” group by initiator order by c descending, which query would return people whose emails I do not promptly open, ordered by how many emails they send which I fail to open within 3 days.

In another query example, the following query may return the list of people I most frequently phone in the Boston (617 area code) area:

select recipient, count(*) as c from communications where initiator=me and contact_method=phone and recipient_address like “617”.

Of course SQL interfaces are not the most user-friendly. Accordingly, a user could be presented with a simple interface that is based on any number of reporting tools that can be used to make accessing SQL databases easier. Some combination of reporting tools, macros (stored queries) and wizards could be utilized to help novice users define groups.

Referring back to the illustrated embodiment, it may also be determined whether the membership list has been verified in operation 216. For example, the creator of the group's membership rules may be asked to verify the accuracy of the membership list or whether the membership list matches the creator's expectations for such group. Depending upon the security consideration surrounding group membership, the verification procedures for membership may vary. For example, users that are labeled as “friends” in a user's address book may not require verification. For instance, it may not cause any problems if a person's plumber temporarily shows up in the “friends” list. However, it may not be desirable to have a user's actual friends dropping off the “friends” list. For a list of “MIT students”, it may be useful to periodically check that the members can still access their @mit.edu email. In another example, the verification process for “nuclear launch codes” for @top-secret.gov mailing list may be very extensive. In this example, it may be very important to ensure that the recipients of such critical list still have access to their @top-secret.gov email, have successfully logged into a computer terminal, which is locked in a room that is sealed and has an iris matching biometrics system, and have not had any unexplained absences from work.

If the membership list is not verified (e.g., the creator does not approve the membership list), new rules may again be established or modified for the particular group (e.g., by the creator or a delegated user) in operation 204. For instance, the group creator is prompted to modify the current group rules. Otherwise, the membership list may be used in operation 218.

A particular group policy and resulting membership list could be utilized for any suitable purpose, such as email lists, other communications (sending or receiving), organizing communication, limiting social networking access, event planning invitation lists, organization of objects (e.g., photos, files, etc.), allowing members use of their keycard to open a door, etc.

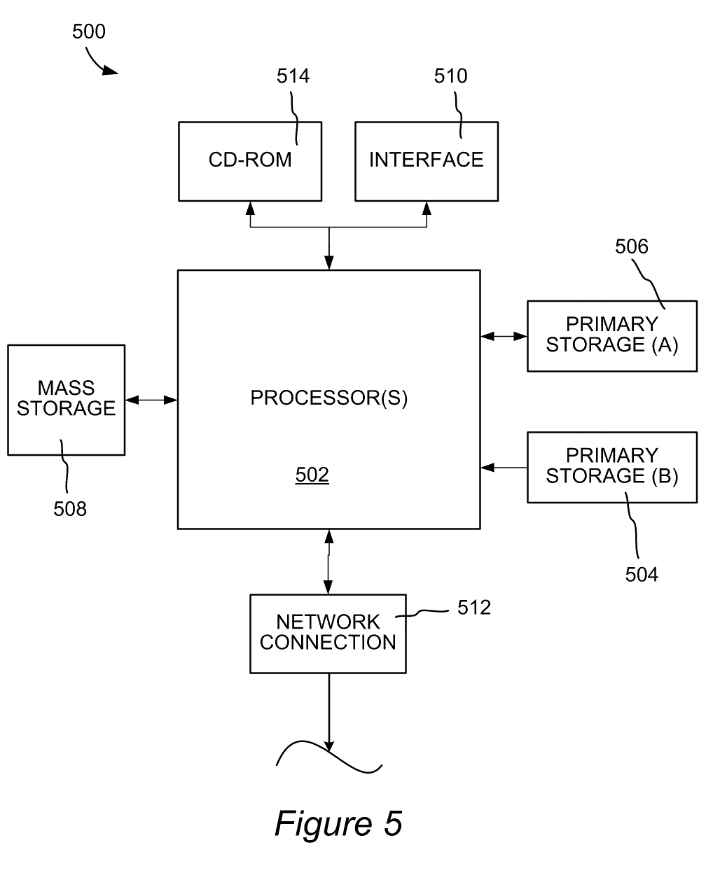

FIG. 5 illustrates a typical computer system that, when appropriately configured or designed, can serve as a dynamic group generator system. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers and microprocessors such as programmable devices (e.g., CPLDs and FPGAs) and unprogrammable devices such as gate array ASICs or general-purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described herein. A mass storage device 508 is also coupled bi-directionally to CPU 502 and provides additional data storage capacity and may include any of the computer-readable media described herein. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 is also coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications network using an external connection as shown generally at 512. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to group policy rules, group information, user information, membership lists, resources, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. For example, rather than a group comprising a list of people, a dynamic group can comprise a list of times or a list of places. For instance, a group may be defined as a list of times for a given person and place (e.g., the number of days that I was in Sunnyale last month).Therefore, the present embodiments are to be considered as illustrative and not restrictive and the invention is not to be limited to the details given herein, but may be modified within the scope and equivalents of the appended claims.

1. A method of creating or modifying a group of users, comprising:
receiving a request from a first user to create or modify a current group;
receiving one or more rules from the first user for specifying members of the current group based on user information that was or will be collected for a plurality of users, wherein the collected user information includes at least user presence information or user communication data; and
retaining a membership policy for the current group based on the received one or more rules, wherein the membership policy for the current group is accessibly usable so as to dynamically allow a selected set of users, who each have corresponding collected user information which meets the membership policy, to become members of the current group, wherein the selected set of users is changeable over time as different user information is collected over time.

2. The method of claim 1, further comprising periodically updating the set of users that are members of the current group based on the membership policy for such current group, wherein each periodic updating operation is based on a current set of collected user information.

3. The method of claim 1, wherein the membership policy is based only on user information that has been verified to meet a predefined reliability specification.

4. The method of claim 1, wherein the one or more rules each specify one or more of the following: a user type, a user location, or a time and wherein the one or more rules specify at least one conditional operator.

5. The method of claim 4, wherein the user type is specified by one or more other rules.

6. The method of claim 5, wherein the user type specifies a category of social relationship with respect to the first user.

7. The method of claim 5, further comprising suggesting one or more suggested rules to the first user for the current group so that the first user may include any of the one or more suggested rules in the one or more rules from the first user, wherein the one or more rules are obtained from previously received rules from other users.

8. An apparatus comprising at least a processor and a memory, wherein the processor and/or memory are configured to perform the following operations:
receiving a request from a first user to create or modify a current group;
receiving one or more rules from the first user for specifying members of the current group based on user information that was or will be collected for a plurality of users, wherein the collected user information includes at least user presence information or user communication data; and
retaining a membership policy for the current group based on the received one or more rules, wherein the membership policy for the current group is accessibly usable so as to dynamically allow a selected set of users, who each have corresponding collected user information which meets the membership policy, to become members of the current group, wherein the selected set of users is changeable over time as different user information is collected over time.

9. The apparatus of claim 8, wherein the processor and/or memory are further configured to periodically update the set of users that are members of the current group based on the membership policy for such current group, wherein each periodic updating operation is based on a current set of collected user information.

10. The apparatus of claim 8, wherein the membership policy is based only on user information that has been verified to meet a predefined reliability specification.

11. The apparatus of claim 8, wherein the one or more rules each specify one or more of the following: a user type, a user location, or a time and wherein the one or more rules specify at least one conditional operator.

12. The apparatus of claim 11, wherein the user type is specified by one or more other rules.

13. The apparatus of claim 12, wherein the user type specifies a category of social relationship with respect to the first user.

14. The apparatus of claim 12, wherein the processor and/or memory are further configured to suggest one or more suggested rules to the first user for the current group so that the first user may include any of the one or more suggested rules in the one or more rules from the first user, wherein the one or more rules are obtained from previously received rules from other users.

15. At least one computer readable storage medium having computer program instructions stored thereon that are arranged to perform the following operations:
receiving a request from a first user to create or modify a current group;
receiving one or more rules from the first user for specifying members of the current group based on user information that was or will be collected for a plurality of users, wherein the collected user information includes at least user presence information or user communication data; and
retaining a membership policy for the current group based on the received one or more rules, wherein the membership policy for the current group is accessibly usable so as to dynamically allow a selected set of users, who each have corresponding collected user information which meets the membership policy, to become members of the current group, wherein the selected set of users is changeable over time as different user information is collected over time.

16. The at least one computer readable storage medium of claim 15, wherein the computer program instructions stored thereon that are further arranged to periodically update the set of users that are members of the current group based on the membership policy for such current group, wherein each periodic updating operation is based on a current set of collected user information.

17. The at least one computer readable storage medium of claim 15, wherein the membership policy is based only on user information that has been verified to meet a predefined reliability specification.

18. The at least one computer readable storage medium of claim 15, wherein the one or more rules each specify one or more of the following: a user type, a user location, or a time and wherein the one or more rules specify at least one conditional operator.

19. The at least one computer readable storage medium of claim 18, wherein the user type is specified by one or more other rules.

20. The at least one computer readable storage medium of claim 19, wherein the user type specifies a category of social relationship with respect to the first user.

21. The at least one computer readable storage medium of claim 19, wherein the computer program instructions stored thereon that are further arranged to suggest one or more suggested rules to the first user for the current group so that the first user may include any of the one or more suggested rules in the one or more rules from the first user, wherein the one or more rules are obtained from previously received rules from other users.
